(19) United States
(12) Patent Application Publication
(10) Pub. No.: US 2014/0028653 A1
(43) Pub. Date: Jan. 30, 2014

(54) DISPLAY DEVICE

(71) Applicant: Japan Display Inc., Tokyo (JP)

(72) Inventor: Kozo YASUDA, Mobara (JP)

(73) Assignee: Japan Display Inc., Tokyo (JP)

(21) Appl. No.: 13/951,794

(22) Filed: Jul. 26, 2013

(30) Foreign Application Priority Data
Jul. 30, 2012 (JP) 2012-167883

(51) Int. Cl. G09G 3/36

(52) U.S. Cl. CPC G09G 3/3674
USPC 345/212; 345/90

(57) ABSTRACT

In a display device using an address decoder circuit as a drive circuit, a malfunction is prevented even when a display drive frequency becomes high. The display device includes a plurality of first scanning lines inputting a scanning voltage to a plurality of pixels, a plurality of second scanning lines inputting a scanning voltage to the plurality of pixels, and a scanning line drive circuit supplying the scanning voltages to the pluralities of first and second scanning lines. When N is an integer of 2 or more, the first scanning lines and the second scanning lines are grouped into kN× . . . ×k2 groups. An address decoder circuit that drives scanning lines in each of the groups is composed of a CMOS circuit.

### CROSS-REFERENCE TO RELATED APPLICATION

The present application claims priority from Japanese application JP 2012-167883 filed on Jul. 30, 2012, the content of which is hereby incorporated by reference into this application.

### BACKGROUND OF THE INVENTION

1. Field of the Invention

The present invention relates to a display device such as a liquid crystal display device, and more particularly to a technique effectively applied to a two-dimensional address type display device.

2. Description of the Related Art

FIG. 1 shows an equivalent circuit of a related-art TFT type active matrix liquid crystal display panel.

As shown in FIG. 1, the related-art liquid crystal display panel has a plurality of scanning lines (also referred to as gate lines) (GL) and a plurality of video lines (also referred to as source lines or drain lines) (DL), both of which are formed on a surface on a liquid crystal side of one of a pair of substrates that are arranged to face each other via liquid crystal. The plurality of scanning lines (GL) and the plurality of video lines (DL) are formed so as to be perpendicular to each other.

Regions surrounded by the scanning lines (GL) and the video lines (DL) are sub-pixel regions. In each of the sub-pixel regions, a thin film transistor (TFT) is disposed. The thin film transistor constitutes an active element whose gate, drain (or source), and source (or drain) are connected to the scanning line, the video line, and a pixel electrode (PX), respectively. Since liquid crystal is present between the pixel electrode (PX) and a counter electrode (also referred to as common electrode) (CT), a liquid crystal capacitor (Clc) is formed between the pixel electrode (PX) and the counter electrode (CT). Although a storage capacitor (Ckdd) is actually disposed between the pixel electrode (PX) and the counter electrode (CT), the storage capacitor (Ckdd) is not shown in FIG. 1.

Each of the scanning lines (GL) is connected to a vertical scanning circuit (also referred to as gate driver) (XDV). The vertical scanning circuit (XDV) sequentially supplies a selection scanning signal to each of the scanning lines (GL).

Each of the video lines (DL) is connected to a horizontal scanning circuit (also referred to as source driver or drain driver) (YDV). The horizontal scanning circuit (YDV) outputs R, G, and B video voltages (so-called gray-scale voltages) to each of the video lines (DL) in one horizontal scanning period.

In FIG. 1, VSYNC represents a vertical synchronizing signal, HSYNC represents a horizontal synchronizing signal, CK represents a dot clock, and Data represents a video data.

### SUMMARY OF THE INVENTION

In a small panel such as a liquid crystal display panel used in a mobile phone or the like, it is conceivable that wirings cannot be wired in the liquid crystal display panel when the number of pixels is increased due to an increase in definition.

To solve the problem, JP 2010-078896 A and JP 2010-250134 A each disclose the use of an address decoder circuit for the vertical scanning circuit (XDV).

However, with a further increase in definition of a liquid crystal display panel, a display drive frequency also becomes high.

Then, when the address decoder circuits disclosed in JP 2010-078896 A and JP 2010-250134 A are used each as a drive circuit in a liquid crystal display panel, a drive speed may not make it in time.

The invention has been made to solve the problem in the related art, and it is an object of the invention to provide a technique enabling the prevention of malfunction in a display device using an address decoder circuit as a drive circuit even when a display drive frequency becomes high.

The above and other objects and novel features of the invention will be apparent from the description of the specification and the accompanying drawings.

Typical outlines of the invention disclosed herein will be briefly described below.

(1) A display device includes: a plurality of pixels; a plurality of first scanning lines inputting a first scanning voltage to the plurality of pixels; a plurality of second scanning lines inputting a second scanning voltage to the plurality of pixels; and a scanning line drive circuit supplying the scanning voltages to the pluralities of first and second scanning lines, wherein when N is an integer of 2 or more, the first scanning lines and the second scanning lines are grouped into kN× . . . ×k2 groups, and address decoder circuits at first to (N−1)th stages, which drive scanning lines in each of the groups at the first to (N−1)th stages, are composed of CMOS circuits.

(2) A display device includes: a plurality of pixels; a plurality of scanning lines inputting a scanning voltage to the plurality of pixels; and a scanning line drive circuit supplying the scanning voltage to the plurality of scanning lines, wherein when N is an integer of 2 or more, the scanning lines are grouped into kN× . . . ×k2 groups, and address decoder circuits at first to (N−1)th stages, which drive scanning lines in each of the groups, are composed of CMOS circuits.

(3) Moreover, the absolute value of gate voltages of a p-type transistor and an n-type transistor that constitute a CMOS circuit is made higher than that of drive pulse voltages input to the p-type transistor and the n-type transistor that constitute the CMOS circuit.

(4) Moreover, the address decoder circuit at the first stage outputs a selection scanning voltage to the scanning lines in a cycle of (k1+1) horizontal scanning periods.

A typical effect obtained by the invention disclosed herein will be briefly described below.

According to the invention, a malfunction can be prevented in a display device using an address decoder circuit as a drive circuit even when a display drive frequency becomes high.

### BRIEF DESCRIPTION OF THE DRAWINGS

FIG. 1 shows an equivalent circuit of a related-art TFT type active matrix liquid crystal display panel.

FIG. 2 shows an equivalent circuit of a TFT type active matrix liquid crystal display panel of an embodiment of the invention.

FIG. 3 is a timing diagram for explaining a method for driving the liquid crystal display panel of the embodiment of the invention.

FIG. 4 explains a problem in the method for driving the liquid crystal display panel of the embodiment of the invention.

FIG. 5 is a timing diagram for explaining another method for driving the liquid crystal display panel of the embodiment of the invention.

FIG. 6 shows an equivalent circuit of a modified example of the TFT type active matrix liquid crystal display panel of the embodiment of the invention.

### DETAILED DESCRIPTION OF THE INVENTION

Hereinafter, an embodiment of the invention will be described in detail with reference to the drawings.

Throughout the drawings for explaining the embodiment, components having the same function are denoted by the same reference numeral and sign, and the repetitive description thereof is omitted. The embodiment described below does not limit the interpretation of the scope of claims of the invention.

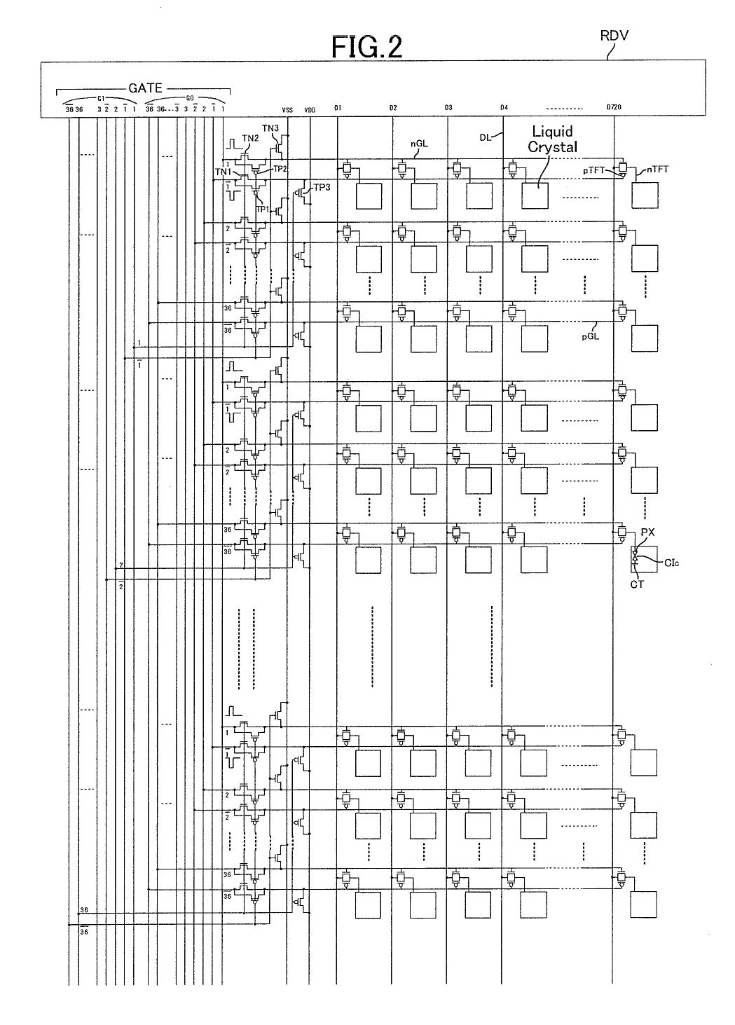

FIG. 2 shows an equivalent circuit of a TFT type active matrix liquid crystal display panel of the embodiment of the invention.

In the embodiment as shown in FIG. 2, a semiconductor chip constituting a drive circuit (RDV) in which a vertical scanning circuit (XDV) and a horizontal scanning circuit (YDV) are integrated with each other is mounted on one of a pair of substrates that are arranged to face each other via liquid crystal. A drive circuit (RDV) may be composed of poly-Si thin film transistors, and the drive circuit (RDV) may be formed on a surface on a liquid crystal side of one of a pair of substrates constituting a liquid crystal display panel.

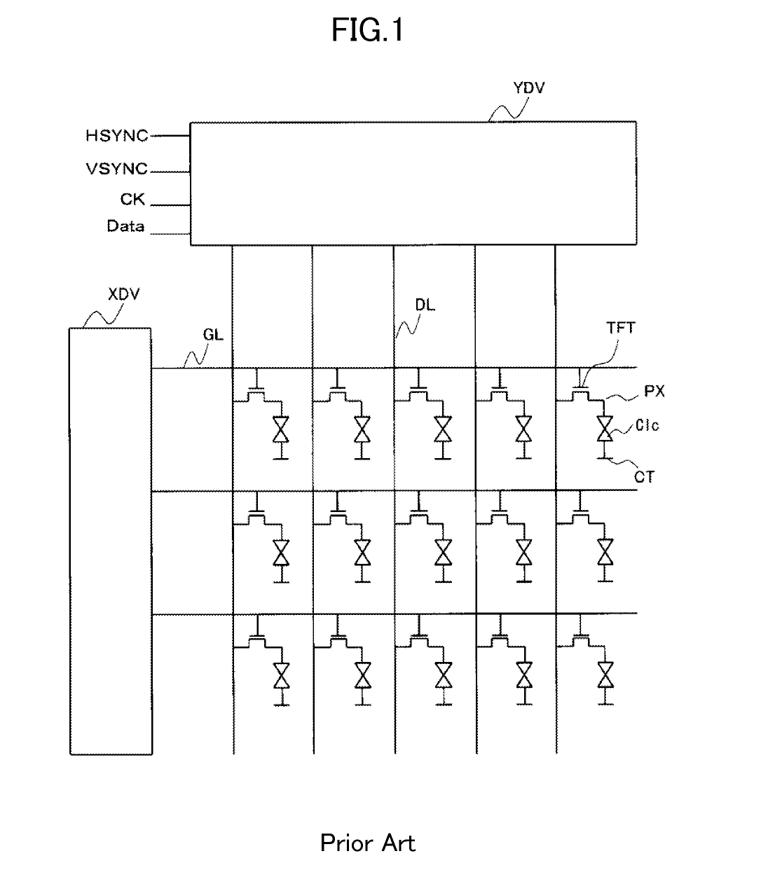

In the liquid crystal display panel of the embodiment, a parallel circuit composed of a p-type MOS transistor (pTFT) and an n-type MOS transistor (nTFT) is used, instead of the thin film transistor (TFT) shown in FIG. 1, as an active element in each of sub-pixels.

A gate of the p-type MOS transistor (pTFT) is connected to a first scanning line (pGL), a drain (or source) thereof is connected to a video line (DL), and a source (or drain) thereof is connected to a pixel electrode (PX). A gate of the n-type MOS transistor (nTFT) is connected to a second scanning line (nGL), a drain (or source) thereof is connected to the video line (DL), and a source (or drain) thereof is connected to the pixel electrode (PX).

Since liquid crystal is present between the pixel electrode (PX) and a counter electrode (also referred to as common electrode) (CT), a liquid crystal capacitor (Clc) is formed between the pixel electrode (PX) and the counter electrode (CT). Although a storage capacitor (Ckdd) is actually disposed between the pixel electrode (PX) and the counter electrode (CT), the storage capacitor (Ckdd) is not shown in FIG. 2.

Each of the video lines (DL) is connected to the drive circuit (RDV) having the horizontal scanning circuit and the vertical scanning circuit incorporated therein. The drive circuit (RDV) outputs R, G, and B video voltages (so-called gray-scale voltages) to the video line (DL) in one horizontal scanning period.

In FIG. 1, VSYNC represents a vertical synchronizing signal, HSYNC represents a horizontal synchronizing signal, CK represents a dot clock, and Data represents video data.

The liquid crystal display panel of the embodiment is configured as follows: a first substrate (also referred to as TFT substrate or active matrix substrate) (not shown) on which pixel electrodes, active elements, and the like are disposed and a second substrate (also referred to as counter substrate) (not shown) on which color filters and the like are formed are overlapped with each other with a predetermined gap therebetween; the substrates are bonded together with a frame-shaped sealing material disposed between the substrates in the vicinity of peripheral portions thereof; liquid crystal is filled inside the sealing material between the substrates from a liquid crystal filling port disposed at a portion of the sealing material and sealed therein; and further a polarizer is attached to the outside of each of the substrates.

In this manner, the liquid crystal display panel of the embodiment has a structure in which liquid crystal is interposed between the pair of substrates. When the liquid crystal display panel is of a TN type or VK type, the counter electrode is disposed on the second substrate (counter substrate) side. When the liquid crystal display panel is of an IPS type, the counter electrode is disposed on the first substrate (TFT substrate) side.

Since the invention has no relationship with the internal structure of the liquid crystal display panel, detailed description of the internal structure of the liquid crystal display panel is omitted. Further, the invention can be applied to liquid crystal display panels of any structure.

Hereinafter, the liquid crystal display panel of the embodiment will be described using an example in which the number of each of the first scanning lines (pGL) and the second scanning lines (nGL) is 1280.

In the embodiment, the first scanning lines (pGL) and the second scanning lines (nGL) are grouped into k2 groups. The numbers of the first scanning lines (pGL) and the second scanning lines (nGL) in each of the groups are equal to each other and each up to k1. Here, k1 is an integer of k2 or less.

In FIG. 2, since k1 is 36 and k2 is 36, the first scanning lines (pGL) and the second scanning lines (nGL) are grouped into 36 groups in the embodiment.

Moreover, the drive circuit (RDV) has a first terminal group (G0) and a second terminal group (G1). The first terminal group (G0) has terminals that output 1st to 36th positive-phase voltages and terminals that output 1̅st to 3̅6̅th negative-phase voltages. Similarly, the second terminal group (G1) has terminals that output 1st to 36th positive-phase voltages and terminals that output 1̅st to 3̅6̅th negative-phase voltages.

In the embodiment, one end of each of the first scanning lines (pGL) is connected to a parallel circuit composed of a p-type MOS transistor (TP1) and an n-type MOS transistor (TN1). Between each of the first scanning lines (pGL) and a positive-side reference power source (herein, a voltage VDD whose voltage level is High level (hereinafter referred to as H level)), a p-type MOS transistor (TP3) is connected for preventing the first scanning line (pGL) from being brought into a floating state when a non-selection scanning voltage is supplied to each of the first scanning lines (pGL).

One end of each of the second scanning lines (nGL) is connected to a parallel circuit composed of a p-type MOS transistor (TP2) and an n-type MOS transistor (TN2). Between each of the second scanning lines (nGL) and a negative-side reference power source (herein, a voltage VSS whose voltage level is Low level (hereinafter referred to as L level)), an n-type MOS transistor (TN3) is connected for preventing the second scanning line (nGL) from being brought into a floating state when a non-selection scanning voltage is supplied to each of the second scanning lines (nGL).

Here, gate wirings connected to the terminals that output the negative-phase voltages are defined as first gate wirings, while gate wirings connected to the terminals that output the positive-phase voltages are defined as second gate wirings. A gate of the p-type MOS transistor (TP1), a gate of the p-type MOS transistor (TP2), and a gate of the n-type MOS transistor (TN3) are connected to one of the first gate wirings connected to the terminals that output the negative-phase voltages in the second terminal group (G1). A gate of the n-type MOS transistor (TN1), a gate of the n-type MOS transistor (TN2), and a gate of the p-type MOS transistor (TP3) are connected to one of the second gate wirings connected to the terminals that output the positive-phase voltages in the second terminal group (G1).

A source (or drain) of the p-type MOS transistor (TP1) and a source (or drain) of the n-type MOS transistor (TN1) are connected to one of the first gate wirings connected to the terminals that output the negative-phase voltages in the first terminal group (G0). A source (or drain) of the p-type MOS transistor (TP2) and a source (or drain) of the n-type MOS transistor (TN2) are connected to one of the second gate wirings connected to the terminals that output the positive-phase voltages in the first terminal group (G0).

In FIG. 2, the drive circuit (RDV) may have a circuit configuration in which the vertical scanning circuit (XDV) and the horizontal scanning circuit (YDV) are separately disposed as shown in FIG. 1.

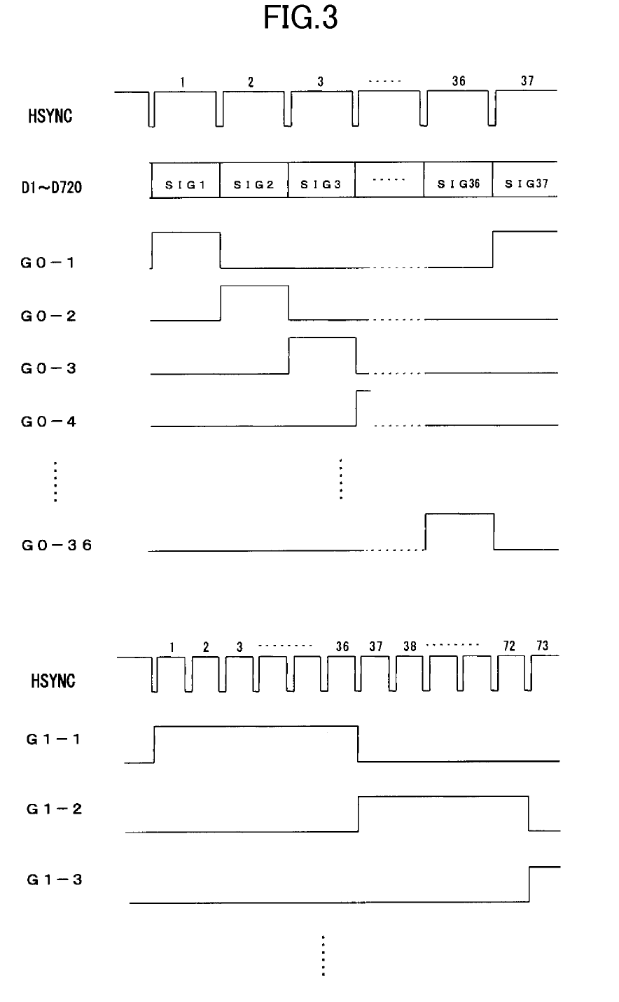

FIG. 3 is a timing diagram for explaining a method for driving the liquid crystal display panel of the embodiment.

As shown by G0-1 to G0-36 in FIG. 3, the drive circuit (RDV) sequentially outputs, every horizontal scanning period, a selection scanning voltage at H level to the terminals that output the 1st to 36th positive-phase voltages in the first terminal group (G0). Although not shown in the drawing, the drive circuit (RDV) sequentially outputs, every horizontal scanning period, a reverse voltage at L level (that is, a voltage obtained by reversing the selection scanning voltage at H level) to the terminals that output the 1̅st to 3̅6̅th negative-phase voltages in the first terminal group (G0) (base 36).

Moreover, as shown by G1-1 to G1-36 in FIG. 3, the drive circuit (RDV) sequentially outputs, every 36 horizontal scanning periods, a selection scanning voltage at H level to the terminals that output the 1st to 36th positive-phase voltages in the second terminal group (G1). Although not shown in the drawing, the drive circuit (RDV) sequentially outputs, every 36 horizontal scanning periods, a reverse voltage at L level (that is, a voltage obtained by reversing the selection scanning voltage at H level) to the terminals that output the 1̅st to 3̅6̅th negative-phase voltages in the second terminal group (G1) (base 36).

That is, the drive circuit (RDV) sequentially outputs, every 36 horizontal scanning periods, the selection scanning voltage and the reverse voltage of the selection scanning voltage to a bundle of 36 first scanning lines (pGL) and a bundle of 36 second scanning lines (nGL), respectively.

When the selection scanning voltage at H level is output to one terminal selected in the terminals that output the 1st to 36th positive-phase voltages in the second terminal group (G1), the n-type MOS transistors (TN1) and n-type MOS transistors (TN2) whose gates are connected to the second gate wiring that is connected to the selected one terminal are turned on, while the p-type MOS transistors (TP3) whose gates are connected to the second gate wiring that is connected to the selected one terminal are turned off.

Moreover, when the reverse voltage at L level (that is, a reverse voltage of the selection scanning voltage at H level) is output to one terminal selected in the terminals that output the 1̅st to 3̅6̅th negative-phase voltages in the second terminal group (G1), the p-type MOS transistors (TP1) and p-type MOS transistors (TP2) whose gates are connected to the first gate wiring that is connected to the selected one terminal are turned on, while the n-type MOS transistors (TN3) whose gates are connected to the first gate wiring that is connected to the selected one terminal are turned off.

Next, when the selection scanning voltage at H level is output to one terminal selected in the terminals that output the 1st to 36th positive-phase voltages in the first terminal group (G0), the selection scanning voltage at H level is output, via the second gate wiring and the p-type MOS transistor (TP2) and the n-type MOS transistor (TN2) that are turned on, to the second scanning line (nGL) that is connected to the selected one terminal.

At the same time, when the reverse voltage at L level (that is, a voltage obtained by reversing the selection scanning voltage at H level) is output to one terminal selected in the terminals that output the 1̅st to 3̅6̅th negative-phase voltages in the first terminal group (G0), the reverse voltage at L level (that is, a voltage obtained by reversing the selection scanning voltage at H level) is output, via the first gate wiring and the p-type MOS transistor (TP1) and the n-type MOS transistor (TN1) that are turned on, to the first scanning line (pGL) that is connected to the selected one terminal.

Due to this, both the p-type MOS transistors (pTFT) and the n-type MOS transistors (nTFT) are turned on, and a video voltage is written from video lines (DL1 to DL720) to the pixel electrode (PX), whereby an image is displayed on the liquid crystal display panel.

In the embodiment, when the numbers of terminals of the first terminal group (G0) and the second terminal group (G1) are equal to each other in case of the total number 1280 of the first scanning lines (pGL) and the total number 1280 of the second scanning lines (nGL), the number of gate wirings connected to the respective terminals of the first terminal group (G0) and the second terminal group (G1) is minimized.

In the embodiment, the number of the second gate wirings connected to the terminals that output the 1st to 36th positive-phase voltages in the first terminal group (G0) is 36; the number of the first gate wirings connected to the terminals that output the 1̅st to 3̅6̅th negative-phase voltages in the first terminal group (G0) is 36; the number of the second gate wirings connected to the terminals that output the 1st to 36th positive-phase voltages in the second terminal group (G1) is 36; and the number of the first gate wirings connected to the terminals that output the 1̅st to 3̅6̅th negative-phase voltages in the second terminal group (G1) is 36. In this case, the total number 144 (=36×4) of gate wirings is minimum.

That is, when wirings are disposed from the drive circuit (RDV) to all of the first scanning lines (pGL) and all of the second scanning lines (nGL) in one-to-one correspondence, 2560 gate wirings are required. In the embodiment, however, the number of wirings is 144, so that the number of wirings can be reduced.

In the embodiment, the case where the first scanning lines (pGL) and the second scanning lines (nGL) are driven using two kinds of terminal groups, the first terminal group (G0) and the second terminal group (G1) (this is referred to as driving by a two-stage configuration), has been described. However, the first scanning lines (pGL) and the second scanning lines (nGL) can be driven by a three-or-more-stage configuration using three kinds or more of terminal groups.

When the drive circuit (RDV) has N kinds of terminal groups and the number of terminals of each of the terminal groups is kn (1≦kn≦N), the total number of gate wirings can be close to the minimum in the case where a difference between a maximum number (maximum kn) and a minimum number (minimum kn) in the numbers of terminals of the terminal groups is 3 or less.

In the embodiment and a modified example described later, two scanning lines, the first scanning line (pGL) and the second scanning line (nGL), are disposed for the reason that an active element in each pixel is composed of the parallel circuit having the p-type MOS transistor (pTFT) and the n-type MOS transistor (nTFT). If an active element in each pixel is composed only of the n-type MOS transistor (nTFT), there is no need to dispose the first scanning line (pGL), the p-type MOS transistor (TP1), the n-type MOS transistor (TN1), and the p-type MOS transistor (TP3). Hence, the terminals that output the 1̅st to 3̅6̅th negative-phase voltages in the first terminal group (G0) and the first gate wirings that are connected to the terminals are also unnecessary.

Similarly, if an active element in each pixel is composed only of the p-type MOS transistor (pTFT), there is no need to dispose the second scanning line (nGL), the p-type MOS transistor (TP2), the n-type MOS transistor (TN2), and the n-type MOS transistor (TN3). Hence, the terminals that output the 1st to 36th positive-phase voltages in the first terminal group (G0) and the second gate wirings that are connected to the terminals are also unnecessary.

In the embodiment, transistors constituting an address decoder circuit have a CMOS configuration including the p-type MOS transistors (TP1 to TP3) and the n-type MOS transistors (TN1 to TN3) for the reason that the rising or falling of a selection scanning voltage (or a reverse voltage of the selection scanning voltage) is made faster to increase the operating speed. For a further increase in speed, gate voltages (a selection scanning voltage and a reverse voltage of the selection scanning voltage that are output from the second terminal group (G1)) applied to the gates of the p-type MOS transistors (TP1 to TP3) and n-type MOS transistors (TN1 to TN3) may be made higher than drive pulse voltages (a selection scanning voltage and a reverse voltage of the selection scanning voltage that are output from the first terminal group (G0)). The term rising of a selection scanning voltage indicates a change in selection scanning voltage from L level to H level, while the term falling of a selection scanning voltage indicates a change in selection scanning voltage from H level to L level.

However, when the drive speed is further increased, glitch noise having a spike shape might occur between the selection scanning voltage and the reverse voltage of the selection scanning voltage that are output from the first terminal group (G0) due to a delay difference of pulse voltage or due to a relationship between the operating speeds of the transistors of the CMOS configuration, in switching between the selection scanning voltage and the reverse voltage of the selection scanning voltage that are output from the second terminal group (G1).

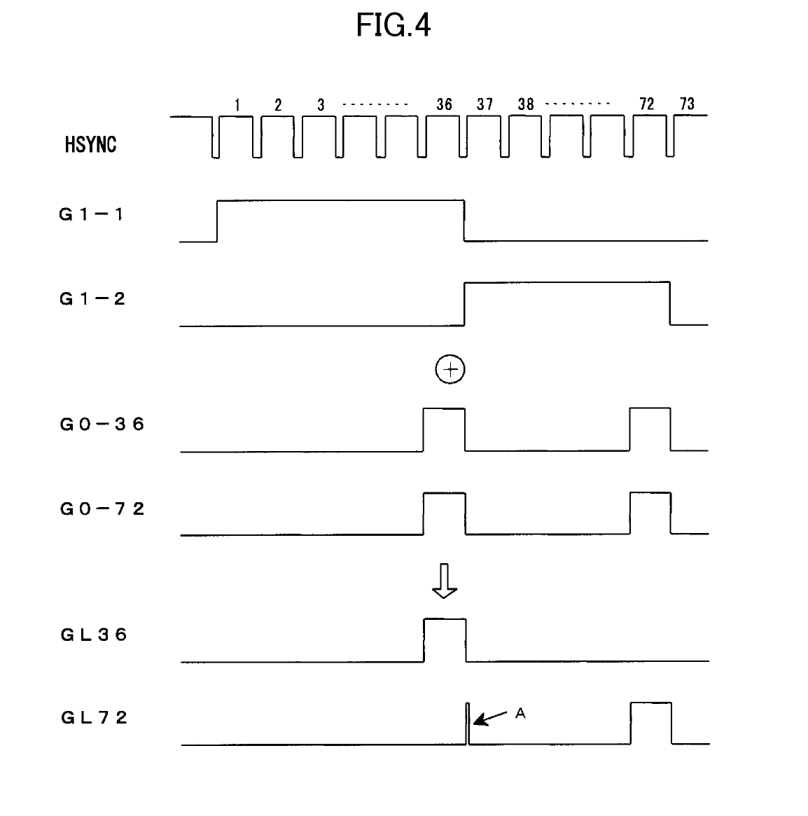

FIG. 4 shows this state.

As shown in FIG. 4, when a delay occurs at the G0-36 selection scanning voltage output from the terminal that outputs the 36th positive-phase voltage in the first terminal group (G0), compared to a changing point from the G1-1 selection scanning voltage output from the terminal that outputs the 1st positive-phase voltage to the G1-2 selection scanning voltage output from the terminal that outputs the 2nd positive-phase voltage in the second terminal group (G1), the G0-36 selection scanning voltage overlaps with a rising portion of the G1-2 selection scanning voltage. Therefore as shown by GL72, glitch noise having a spike shape, shown by A in FIG. 4, occurs on the 72th second scanning line.

When this noise occurs, the n-type MOS transistors (nTFT) whose gates are connected to the 72th second scanning line are turned on and a video voltage is written to a pixel that should not be originally written, causing a malfunction.

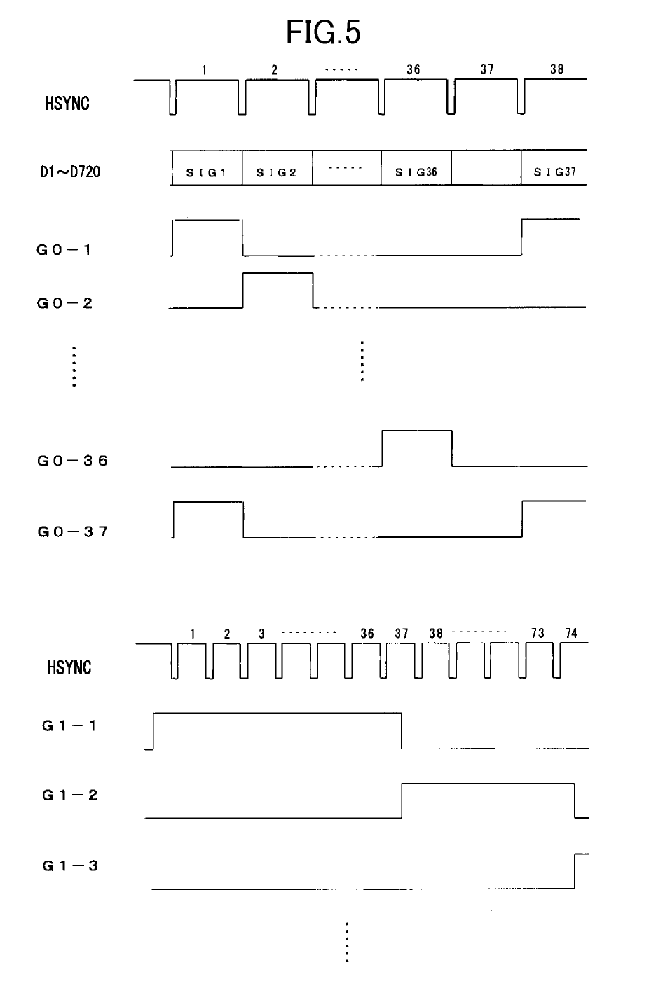

To solve this, a drive timing is changed as shown in FIG. 5.

The cycles of the selection scanning voltage output from the terminals that output the positive-phase voltages and the cycles of the reverse voltage of the selection scanning voltage output from the terminals that output the negative-phase voltages in the first terminal group (G0) are changed from 36 horizontal scanning periods to 37 horizontal scanning periods. In accordance with the changing, settings are changed such that the falling (or rising) timing of the selection scanning voltage output from the terminals that output the positive-phase voltages and the rising (or falling) timing of the reverse voltage of the selection scanning voltage output from the terminals that output the negative-phase voltages in the second terminal group (G1) occur in the middle of a 37th horizontal scanning period.

Moreover, since it is unnecessary to write an image in a sub-pixel in the 37th horizontal scanning period, a video voltage is not output to the video line (DL) in the 37th horizontal scanning period, or a dummy video voltage is output thereto.

As shown by the drive timing in FIG. 5, at the falling (or rising) timing of the selection scanning voltage output from the terminal that outputs the positive-phase voltage in the second terminal group (G1) and the rising (or falling) timing of the reverse voltage of the selection scanning voltage output from the terminal that outputs the negative-phase voltage in the second terminal group (G1), the selection scanning voltage output from the terminal that outputs the positive-phase voltage in the first terminal group (G0) is necessarily at L level and the reverse voltage of the selection scanning voltage output from the terminal that outputs the negative-phase voltage in the first terminal group (G0) is necessarily at H level. Therefore, the glitch noise described above can be eliminated.

### Modified Example

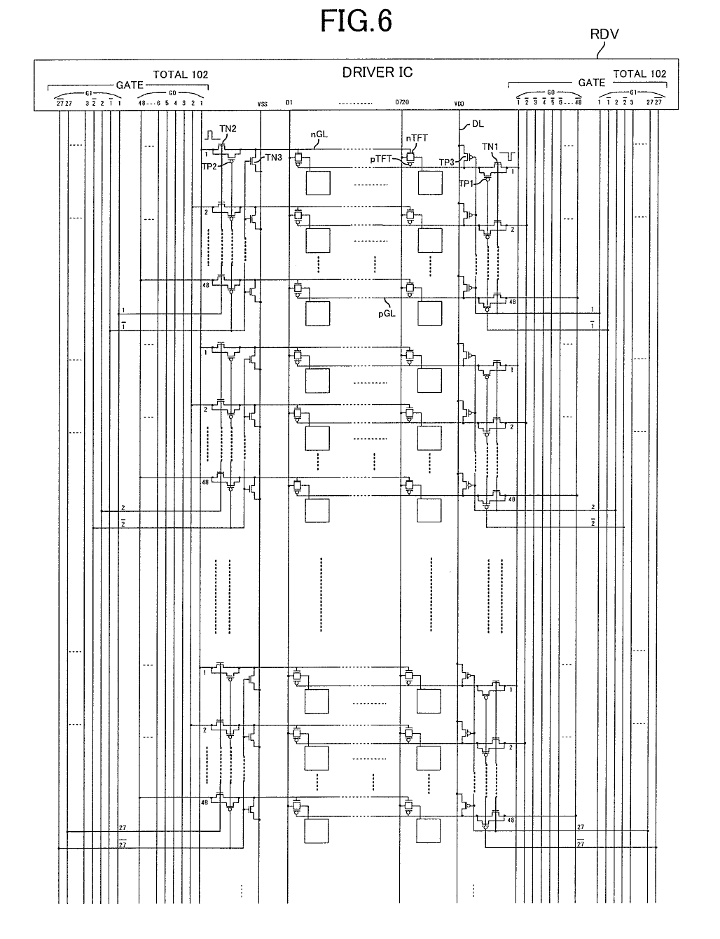

FIG. 6 shows an equivalent circuit of a modified example of the TFT type active matrix liquid crystal display panel of the embodiment of the invention.

In the modified example shown in FIG. 6, circuits that supply a selection scanning voltage to the first scanning lines (pGL) and circuits that supply a selection scanning voltage to the second scanning lines (nGL) are separately arranged on the right and left sides.

In the modified example of FIG. 6, the first scanning lines (pGL) and the second scanning lines (nGL) are grouped into 27 groups.

The drive circuit (RDV) has the first terminal group (G0) and the second terminal group (G1). The first terminal group (G0) has terminals that output 1st to 48th positive-phase voltages and terminals that output 1̅st to 4̅8̅th negative-phase voltages. Similarly, the second terminal group (G1) has terminals that output 1st to 27th positive-phase voltages and terminals that output 1̅st to 2̅7̅th negative-phase voltages.

In the modified example shown in FIG. 6, the number of second gate wirings connected to the terminals that output the 1st to 48th positive-phase voltages in the first terminal group (G0) is 48; the number of first gate wirings connected to the terminals that output the 1̅st to 4̅8̅th negative-phase voltages in the first terminal group (G0) is 48; the number of first gate wirings connected to the terminals that output the 1st to 27th positive-phase voltages in the second terminal group (G1) is 27; and the number of first gate wirings connected to the terminals that output the 1̅st to 2̅7̅th negative-phase voltages in the second terminal group (G1) is 27. Moreover, since the second terminal group (G1) is arranged on the right and left sides, the total number of gate wirings in this case is 204 (=48+48+27+27+27+27). That is, when wirings are wired from the drive circuit (RDV) to all of the first scanning lines (pGL) and all of the second scanning lines (nGL) in one-to-one correspondence, 2560 gate wiring are required. However, the number of wirings can be reduced to 204.

Also in the modified example shown in FIG. 6, the case where the first scanning lines (pGL) and the second scanning lines (nGL) are driven by a two-stage configuration has been described. However, the first scanning lines (pGL) and the second scanning lines (nGL) can be driven by a three-or-more-stage configuration.

Also in the modified example, one end of each of the first scanning lines (pGL) is connected to a parallel circuit composed of the p-type MOS transistor (TP1) and the n-type MOS transistor (TN1). Between each of the first scanning lines (pGL) and the positive-side reference power source (herein, the voltage VDD whose voltage level is H level), the p-type MOS transistor (TP3) is connected for preventing the first scanning line (pGL) from being brought into a floating state when a non-selection scanning voltage is supplied to each of the first scanning lines (pGL).

One end of each of the second scanning lines (nGL) is connected to a parallel circuit composed of the p-type MOS transistor (TP2) and the n-type MOS transistor (TN2). Between each of the second scanning lines (nGL) and the negative-side reference power source (herein, the voltage VSS whose voltage level is L level), the n-type MOS transistor (TN3) is connected for preventing the second scanning line (nGL) from being brought into a floating state when a non-selection scanning voltage is supplied to each of the second scanning lines (nGL).

A gate of the p-type MOS transistor (TP1), a gate of the p-type MOS transistor (TP2), and a gate of the n-type MOS transistor (TN3) are connected to one of the first gate wirings connected to the terminals that output the negative-phase voltages in the second terminal group (G1). A gate of the n-type MOS transistor (TN1), a gate of the n-type MOS transistor (TN2), and a gate of the p-type MOS transistor (TP3) are connected to one of the first gate wirings connected to the terminals that output the positive-phase voltages in the second terminal group (G1).

A source (or drain) of the p-type MOS transistor (TP1) and a source (or drain) of the n-type MOS transistor (TN1) are connected to one of the first gate wirings connected to the terminals that output the negative-phase voltages in the first terminal group (G0). A source (or drain) of the p-type MOS transistor (TP2) and a source (or drain) of the n-type MOS transistor (TN2) are connected to one of the first gate wirings connected to the terminals that output the positive-phase voltages in the first terminal group (G0).

As shown in FIG. 6, the p-type MOS transistor (TP1), the p-type MOS transistor (TP2), and the n-type MOS transistor (TN3) are arranged on one side of a display portion composed of a plurality of sub-pixels. The n-type MOS transistor (TN1), the n-type MOS transistor (TN2), and the p-type MOS transistor (TP3) are arranged on the other side of the display portion with the display portion interposed therebetween.

As described above in the modified example shown in FIG. 6, since the MOS transistors or gate wirings can be arranged on the right and left sides with the display portion interposed therebetween, a picture-frame (right and left places other than the display portion) of the liquid crystal display panel can be made narrow. In the modified example shown in FIG. 6, however, since the gate wirings need to be arranged on the right and left sides with the display portion interposed therebetween, 204 (102×2) gate wirings are necessary. Therefore, an effect of reducing the number of gate wirings is reduced.

In the above description, the p-type MOS transistors (TP1 to TP3) and the n-type MOS transistors (TN1 to TN3) are composed of p-Si thin film transistors. Although, in the embodiment described above, the invention has been described in conjunction with an embodiment in which the invention is applied to a liquid crystal display device, the invention is not limited thereto. It is needless to say that the invention can be applied to an organic EL display device or another display device having scanning lines and a scanning line drive circuit.

While there have been described what are at present considered to be certain embodiments of the invention, it will be understood that various modifications may be made thereto, and it is intended that the appended claims cover all such modifications as fall within the true spirit and scope of the invention.

What is claimed is:

1. A display device comprising:
a plurality of pixels;
a plurality of first scanning lines inputting a first scanning voltage to the plurality of pixels;
a plurality of second scanning lines inputting a second scanning voltage to the plurality of pixels;
a scanning line drive circuit supplying the first scanning voltage and the second scanning voltage to the plurality of first scanning lines and the plurality of second scanning lines, respectively;
first to Nth groups of first gate wirings, the nth group of first gate wirings including kn gate wirings;
first to Nth groups of second gate wirings, the nth group of second gate wirings including kn gate wirings;
a plurality of first series-parallel circuits, each of the first series-parallel circuits being a circuit having (N−1) first to (N−1)th parallel circuits connected in series, each of the parallel circuits being a circuit having a p-type transistor and an n-type transistor connected in parallel; and
a plurality of second series-parallel circuits, each of the second series-parallel circuits being a circuit having (N−1) first to (N−1)th parallel circuits connected in series, each of the parallel circuits being a circuit having a p-type transistor and an n-type transistor connected in parallel, wherein
N, n, and j are an integer of 2 or more, any integer from 1 to N, and any integer from 1 to N−1, respectively,
the plurality of first scanning lines and the plurality of second scanning lines are grouped into kN×k(N−1)× . . . ×k3×k2 groups,
the numbers of the first scanning lines and the second scanning lines in each of the groups are equal to each other and each up to k1, where k1 is an integer of k2 or less,
the plurality of first series-parallel circuits are respectively disposed on the plurality of first scanning lines,
the plurality of second series-parallel circuits are respectively disposed on the plurality of second scanning lines,
one end of each of the first scanning lines is connected to the (N−1)th parallel circuit of the first series-parallel circuit,
one end of each of the second scanning lines is connected to the (N−1)th parallel circuit of the second series-parallel circuit,
the first parallel circuit of each of the first series-parallel circuits is connected to any gate wiring of the first group of first gate wirings,
the first parallel circuit of each of the second series-parallel circuits is connected to any gate wiring of the first group of second gate wirings,
gates of the p-type transistors of the respective jth parallel circuits of each of the first series-parallel circuits and each of the second series-parallel circuits are connected to any gate wiring of the (j+1)th group of first gate wirings, and
gates of the n-type transistors of the respective jth parallel circuits of each of the first series-parallel circuits and each of the second series-parallel circuits are connected to any gate wiring of the (j+1)th group of second gate wirings.

2. A display device according to claim 1, wherein
when m is any integer of from 2 to N−1,
the scanning line drive circuit sequentially outputs a first selection scanning voltage for selecting scanning lines in each of the groups every horizontal scanning period to the first group of k1 second gate wirings and sequentially outputs a reverse voltage of the first selection scanning voltage to the first group of k1 first gate wirings,
sequentially outputs a second selection scanning voltage for selecting scanning lines in one of groups at a second stage, where k2 groups are set as one unit, every k1 horizontal scanning periods to the second group of k2 second gate wirings and sequentially outputs a reverse voltage of the second selection scanning voltage to the second group of k2 first gate wirings, and
sequentially outputs an mth selection scanning voltage for selecting scanning lines in one of groups at an (m+1)th stage, where km groups at an mth stage are set as one unit, every (km×k(m−1)× . . . ×k2×k1) horizontal scanning periods to an (m+1) th group of k(m+1) second gate wirings and sequentially outputs a reverse voltage of the mth selection scanning voltage to an (m+1)th group of k(m+1) first gate wirings.

3. A display device according to claim 1, wherein
each of the pixels has, as an active element, a parallel circuit composed of a p-type pixel transistor and an n-type pixel transistor,
a gate of the p-type pixel transistor is connected to one first scanning line out of the plurality of first scanning lines, and
a gate of the n-type pixel transistor is connected to one second scanning line out of the plurality of second scanning lines.

4. A display device according to claim 1, further comprising:
(N−1) Nth to (2N−2) th p-type transistors connected between each of the first scanning lines and a positive-side reference power line supplied with a positive-side reference voltage; and
(N−1) Nth to (2N−2)th n-type transistors connected between each of the second scanning lines and a negative-side reference power line supplied with a negative-side reference voltage, wherein
a gate of the (j+N−1)th p-type transistor is connected to one gate wiring out of the (j+1) th group of second gate wirings, and
a gate of the (j+N−1)th n-type transistor is connected to one gate wiring out of the (j+1) th group of first gate wirings.

5. A display device according to claim 1, wherein
the first series-parallel circuits and the first group of first gate wirings are arranged on one of sides of a display portion composed of the plurality of pixels,
the second series-parallel circuits and the first group of the second gate wirings are arranged on the other side of the display portion composed of the plurality of pixels with the display portion interposed between the first series-parallel circuits and the first group of first gate wirings, and the second series-parallel circuits and the first group of the second gate wirings, and
the second to Nth groups of first gate wirings and second gate wirings are respectively arranged on both of the sides of the display portion.

6. A display device according to claim 1, wherein
the scanning line drive circuit sequentially outputs, in a cycle of (k1+1) horizontal scanning periods, a first selection scanning voltage for selecting scanning lines in each of the groups every horizontal scanning period to the first group of k1 second gate wirings and sequentially outputs a reverse voltage of the first selection scanning voltage to the first group of k1 first gate wirings, and
synchronizes rising and falling timings of second to Nth selection scanning voltages and rising and falling timings of reverse voltages of the second to Nth selection scanning voltages with the cycle of (k1+1) horizontal scanning periods.

7. A display device comprising:
a plurality of pixels;
a plurality of scanning lines inputting a scanning voltage to the plurality of pixels;
a scanning line drive circuit supplying the scanning voltage to the plurality of scanning lines;
a first group of gate wirings including k1 gate wirings;
second to Nth groups of first gate wirings, the nth group of first gate wirings including kn gate wirings;
second to Nth groups of second gate wirings, the nth group of second gate wirings including kn gate wirings; and
a plurality of series-parallel circuits, each of the series-parallel circuits being a circuit having (N−1) first to (N−1)th parallel circuits connected in series, each of the parallel circuits being a circuit having a p-type transistor and an n-type transistor connected in parallel, wherein
N, n, and j are an integer of 2 or more, any integer from 2 to N, and any integer from 1 to N−1, respectively,
the plurality of scanning lines are grouped into kN×k(N−1)× . . . ×k3×k2 groups;
the number of the scanning lines in each of the groups is up to k1, where k1 is an integer of k2 or less,
the plurality of series-parallel circuits are respectively disposed on the plurality of scanning lines,
one end of each of the scanning lines is connected to the (N−1)th parallel circuit of the series-parallel circuit,
the first parallel circuit of each of the series-parallel circuits is connected to any gate wiring of the first group of gate wirings,
a gate of the p-type transistor of the jth parallel circuit of each of the series-parallel circuits is connected to any gate wiring of the (j+1)th group of first gate wirings, and
a gate of the n-type transistor of the jth parallel circuit of each of the series-parallel circuits is connected to any gate wiring of the (j+1)th group of second gate wirings.

8. A display device according to claim 7, wherein
when m is any integer from 2 to N−1,
the scanning line drive circuit sequentially outputs a first selection scanning voltage for selecting scanning lines in each of the groups every horizontal scanning period to the first group of k1 gate wirings,
sequentially outputs a second selection scanning voltage for selecting scanning lines in one of groups at a second stage, where k2 groups are set as one unit, every k1 horizontal scanning periods to the second group of k2 second gate wirings and sequentially outputs a reverse voltage of the second selection scanning voltage to the second group of k2 first gate wirings, and
sequentially outputs an mth selection scanning voltage for selecting scanning lines in one of groups at an (m+1)th stage, where km groups at an mth stage are set as one unit, every (km×k(m−1)× . . . ×k2×k1) horizontal scanning periods to an (m+1) th group of k (m+1) (2≦m≦N−1) second gate wirings and sequentially outputs a reverse voltage of the mth selection scanning voltage to an (m+1)th group of k(m+1) (2≦m≦N−1) first gate wirings.

9. A display device according to claim 7, further comprising (N−1) Nth to (2N−2)th p-type transistors connected between each of the scanning lines and a positive-side reference power line supplied with a positive-side reference voltage, wherein
a gate of the (j+N−1)th p-type transistor is connected to any gate wiring of the (j+1)th group of second gate wirings.

10. A display device according to claim 7, further comprising (N−1) Nth to (2N−2)th n-type transistors connected between each of the scanning lines and a negative-side reference power line supplied with a negative-side reference voltage, wherein
a gate of the (j+N−1)th n-type transistor is connected to any gate wiring of the (j+1)th group of first gate wirings.

11. A display device according to claim 1, wherein
the second selection scanning voltage is higher in potential than the first selection scanning voltage, and
the mth selection scanning voltage is higher in potential than the first selection scanning voltage.

12. A display device according to claim 7, wherein
the second selection scanning voltage is higher in potential than the first selection scanning voltage, and
the mth selection scanning voltage is higher in potential than the first selection scanning voltage.

13. A display device according to claim 7, wherein
the scanning line drive circuit sequentially outputs, in a cycle of (k1+1) horizontal scanning periods, a first selection scanning voltage for selecting scanning lines in each of the groups every horizontal scanning period to the first group of k1 gate wirings, and
synchronizes rising and falling timings of a second or more selection scanning voltages and rising and falling timings of reverse voltages of the second or more selection scanning voltages with the cycle of (k1+1) horizontal scanning periods.

14. A display device according to claim 6, wherein
the rising and falling timings of the second or more selection scanning voltages and the rising and falling timings of the reverse voltages of the second or more selection scanning voltages are in a (k1+1)th horizontal scanning period of the cycle of (k1+1) horizontal scanning periods.

15. A display device according to claim 13, wherein
the rising and falling timings of the second or more selection scanning voltages and the rising and falling timings of the reverse voltages of the second or more selection scanning voltages are in a (k1+1)th horizontal scanning period of the cycle of (k1+1) horizontal scanning periods.

16. A display device according to claim 6, further comprising:
a plurality of video lines inputting a video voltage to the plurality of pixels; and
a video line drive circuit supplying the video voltage to the plurality of video lines, wherein
the video line drive circuit does not output the video voltage to the plurality of video lines in the (k1+1) th horizontal scanning period of the cycle of (k1+1) horizontal scanning periods.

17. A display device according to claim 13, further comprising:
a plurality of video lines inputting a video voltage to the plurality of pixels; and
a video line drive circuit supplying the video voltage to the plurality of video lines, wherein
the video line drive circuit does not output the video voltage to the plurality of video lines in the (k1+1) th horizontal scanning period of the cycle of (k1+1) horizontal scanning periods.

18. A display device according to claim 6, further comprising:
a plurality of video lines inputting a video voltage to the plurality of pixels; and
a video line drive circuit supplying the video voltage to the plurality of video lines, wherein
the video line drive circuit outputs a dummy video voltage to the plurality of video lines in the (k1+1)th horizontal scanning period of the cycle of (k1+1) horizontal scanning periods.

19. A display device according to claim 13, further comprising:
a plurality of video lines inputting a video voltage to the plurality of pixels; and
a video line drive circuit supplying the video voltage to the plurality of video lines, wherein
the video line drive circuit outputs a dummy video voltage to the plurality of video lines in the (k1+1)th horizontal scanning period of the cycle of (k1+1) horizontal scanning periods.

20. A display device comprising:
a plurality of pixels;
a plurality of first scanning lines inputting a first scanning voltage to the plurality of pixels;
a plurality of second scanning lines inputting a second scanning voltage to the plurality of pixels;
a scanning line drive circuit supplying the first and second scanning voltages to the pluralities of first and second scanning lines, respectively;
a first group of first gate wirings including k1 gate wirings;
a second group of first gate wirings including k1 gate wirings;
a first group of second gate wirings including k2 gate wirings;
a second group of second gate wirings including k2 gate wirings;
a plurality of first parallel circuits, each of the first parallel circuits being a circuit having a p-type transistor and an n-type transistor connected in parallel; and
a plurality of second parallel circuits, each of the second parallel circuits being a circuit having a p-type transistor and an n-type transistor connected in parallel, wherein
the plurality of first scanning lines and the plurality of second scanning lines are grouped into k2 groups,
the numbers of the first scanning lines and the second scanning lines in each of the groups are equal to each other and each up to k1, where k1 is an integer of k2 or less,
the plurality of first parallel circuits are respectively disposed on the plurality of first scanning lines,
the plurality of second parallel circuits are respectively disposed on the plurality of second scanning lines,
one end of each of the first scanning lines is connected to the first parallel circuit,
one end of each of the second scanning lines is connected to the second parallel circuit,
each of the first parallel circuits is connected to any gate wiring of the first group of first gate wirings,
each of the second parallel circuits is connected to any gate wiring of the first group of second gate wirings,
gates of the respective p-type transistors of each of the first parallel circuits and each of the second parallel circuits are connected to any gate wiring of the second group of first gate wirings, and
gates of the respective n-type transistors of each of the first parallel circuits and each of the second parallel circuits are connected to any gate wiring of the second group of second gate wirings.
